(19) United States
(12) Patent Application Publication
(10) Pub. No.: US 2009/0159573 A1
(43) Pub. Date: Jun. 25, 2009

(54) FOUR SURFACES COOLING BLOCK

(76) Inventor: KYU OK HWANG, Bundang-gu (KR)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/268,567

(22) Filed: Nov. 11, 2008

Related U.S. Application Data
(60) Provisional application No. 61/016,204, filed on Dec. 21, 2007.

(51) Int. Cl. B23K 9/00; F28D 21/00

(52) U.S. Cl. 219/121.36; 165/47; 219/121.59

(57) ABSTRACT

A cooling block for coupling a remote plasma source to a resistor is disclosed. As processed substrates become larger for solar panels, organic light emitting diodes, and flat panel displays, a greater amount of cleaning gas and hence, plasma from a remote plasma source, may be necessary. When large amounts of cleaning gas such as fluorine containing gas is ignited into a plasma, the temperature of the remote plasma source that ignites the plasma may become very hot. The hot plasma may transfer heat to adjacent components and to any components through which the plasma flows. By cooling the block connecting the remote plasma source to the resistor, the plasma may be cooled prior to reaching the resistor and hence, prior to reaching the processing chamber.

### CROSS-REFERENCE TO RELATED APPLICATIONS

This application claims benefit of U.S. provisional patent application Ser. No. 61/016,204 (APPM/013016L), filed Dec. 21, 2007, which is herein incorporated by reference.

### BACKGROUND OF THE INVENTION

1. Field of the Invention

Embodiments of the present invention generally relate to a cooling block for coupling a remote plasma source to a resistor.

2. Description of the Related Art

During a plasma deposition process, material deposits not only on the substrate, but also chamber components that are exposed to the plasma. The deposition onto locations other than the substrate is not ideal because over time, flaking may occur. Flaking occurs when material that has been deposited onto chamber surfaces breaks off. The flaking may occur due to expansion and contraction of the material due to temperature fluxuations during processing. The flaking may also occur due to rapid changes in pressure that may occur when a slit valve door is opened to access the processing chamber. When material flakes off, it may fall onto the substrate and contaminate the substrate.

To avoid flaking, plasma processing chambers may need to be periodically cleaned to remove deposits. The technician operating the processing chamber may decide to clean the processing chamber after a predetermined number of deposition processes. It would be beneficial to have a method and an apparatus that cleans the processing chamber to avoid undesired flaking.

### SUMMARY OF THE INVENTION

The present invention generally comprises a cooling block for coupling a remote plasma source to a resistor. In a first embodiment, a cooling block for coupling between a remote plasma source and a resistor comprises an inner body having a cavity extending therethrough, an outer body surrounding the inner body and spaced therefrom, one or more plates extending between and coupled to the inner body and the outer body, the one or more plates occupying less than about 50 percent of the space, and a flange coupled to and extending from the outer body, the flange enclosing a passage extending to the cavity.

In another embodiment, a cooling block for coupling a remote plasma source to a resistor comprises a rectangular shaped first body having a fluid inlet disposed at a first end and a fluid outlet disposed at the second end, and a rectangular shaped second body enclosed within the first body, the second body having a cylindrical cavity therein, wherein the second body is coupled to the first body such that the entire perimeter of at least a portion of the second body is spaced from the first body.

In another embodiment, a plasma processing apparatus comprises a processing chamber having a backing plate, an inlet block coupled to the backing plate, a power source coupled to the inlet block, a resistor coupled to the inlet block, a cooling block coupled to the resistor, the cooling block having a body with a flange extending therefrom, an inside portion having a passage therethrough for plasma to flow therein, an outside portion coupled to the inside portion with one or more plates such that greater than about 50 percent of an outside surface of the inside portion is spaced from the outside portion, a fluid source coupled to the cooling block, and a remote plasma source coupled to the flange of the cooling block.

In another embodiment, a plasma processing method comprising igniting a plasma in a remote plasma source, flowing the plasma from the remote plasma source through a cooling block, a resistor, an inlet block, and into a plasma processing chamber, flowing a cooling fluid through the cooling block, wherein the plasma flows through a body disposed within the cooling block, and wherein the cooling fluid flows along the entire perimeter of the outside of the body for at least a portion of the length of the body, processing a substrate in a plasma environment.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross sectional view of a plasma enhanced chemical vapor deposition apparatus according to one embodiment of the invention.

FIG. 2 is a schematic isometric view of a cooling block according to one embodiment of the invention.

FIG. 3 is a schematic cross sectional isometric view of a cooling block according to another embodiment of the invention.

FIG. 4A is a schematic top view of a cooling block according to one embodiment of the invention.

FIG. 4B is a schematic bottom cross sectional view of the cooling block of FIG. 4A.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

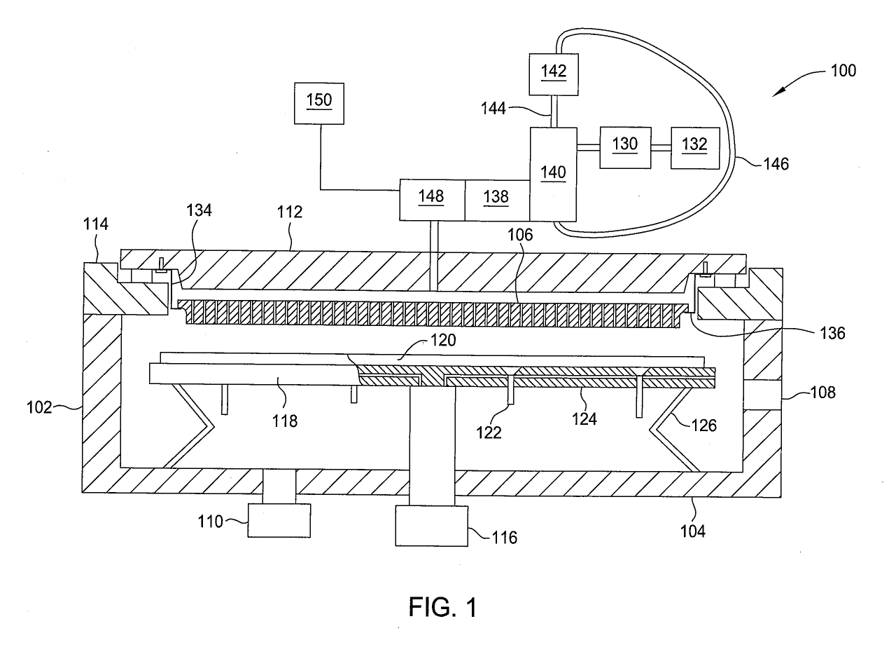

The present invention generally comprises a cooling block for coupling a remote plasma source to a resistor in a plasma enhanced chemical vapor deposition (PEDVD) apparatus. FIG. 1 is a schematic cross sectional view of a PECVD apparatus according to one embodiment of the invention. The apparatus includes a chamber 100 in which one or more films may be deposited onto a substrate 120. One suitable PECVD apparatus which may be used is available from Applied Materials, Inc., located in Santa Clara, Calif. While the description below will be made in reference to a PECVD apparatus, it is to be understood that the invention is equally applicable to other processing chambers as well, including those made by other manufacturers.

The chamber 100 generally includes walls 102, a bottom 104, a showerhead 106, and susceptor 118 which define a process volume. The process volume is accessed through a slit valve opening 108 such that the substrate 120 may be transferred in and out of the chamber 100. The susceptor 118 may be coupled to an actuator 116 to raise and lower the susceptor 118. Lift pins 122 are moveably disposed through the susceptor 118 to support a substrate 120 prior to placement onto the susceptor 118 and after removal from the susceptor 118. The susceptor 118 may also include heating and/or cooling elements 124 to maintain the susceptor 118 at a desired temperature. The susceptor 118 may also include grounding straps 126 to provide RF grounding at the periphery of the susceptor 118.

The showerhead 106 may be coupled to the backing plate 112 by one or more coupling supports to help prevent sag and/or control the straightness/curvature of the showerhead 106. Additionally and/or alternatively, a center coupling mechanism may be present to couple the backing plate 112 to the showerhead 106. The center coupling mechanism may surround a backing plate support ring (not shown) and be suspended from a bridge assembly (not shown). The showerhead 106 may additionally be coupled to the backing plate 112 by a bracket 134. The bracket 134 may have a ledge 136 upon which the showerhead 106 may rest. The backing plate 112 may rest on a ledge 114 coupled with the chamber walls 102 to seal the chamber 100.

A gas source 132 is coupled to the backing plate 112 to provide both processing gas and cleaning gas through gas passages in the showerhead 106 to the substrate 120. The processing gases travel through a remote plasma source 130. A microwave current from a microwave source (not shown) coupled to the remote plasma source 130 may ignite the plasma. The cleaning gas may be further excited by the RF power source 150 provided to the showerhead 106. Suitable cleaning gases include by are not limited to NF₃, F₂, and SF₆. The cleaning gas may be ignited into a plasma within the remote plasma source 130. The plasma may then flow from the remote plasma source 130 to a resistor (or RF choke) 138. The remote plasma source 130 may be coupled to the resistor by a cooling block 140.

At high flow rates, fluorine plasmas may reach very high temperatures. In one embodiment, the fluorine containing plasma may flow from the remote plasma source 130 at a rate between about 25 slm to about 35 slm. When the plasma is very hot, the remote plasma source 130 is heated as are any components through which the plasma may flow. The high temperatures may be undesirable as they could lead to expansion and contraction and/or damage of chamber components. The remote plasma source 130 and the plasma flowing therefrom may be cooled by the cooling block 140. A cooling fluid may be introduced to the cooling bloc from a cooling fluid source 142 via conduit 144. The cooling fluid may enter at the top of the cooling block 140 and exit at the bottom of the cooling block 140. The cooling fluid may then return to the cooling fluid source through conduit 146.

After the plasma passes through the cooling block 140 and the resistor 138, the plasma enters an inlet block 148 before entering the processing chamber 100 through the backing plate 112. A vacuum pump 110 is coupled to the chamber 100 at a location below the susceptor 118 to maintain the process volume 106 at a predetermined pressure. A RF power source 150 is coupled to the backing plate 112 and/or to the showerhead 106 to provide a RF current to the showerhead 106. The RF current creates an electric field between the showerhead 106 and the susceptor 118 so that a plasma may be generated from the gases between the showerhead 106 and the susceptor 118. Various frequencies may be used, such as a frequency between about 0.3 MHz and about 200 MHz. In one embodiment, the RF current is provided at a frequency of 13.56 MHz. The spacing between the top surface of the substrate 120 and the showerhead 106 may be between about 400 mil and about 1,200 mil. In one embodiment, the spacing may be between about 400 mil and about 800 mil.

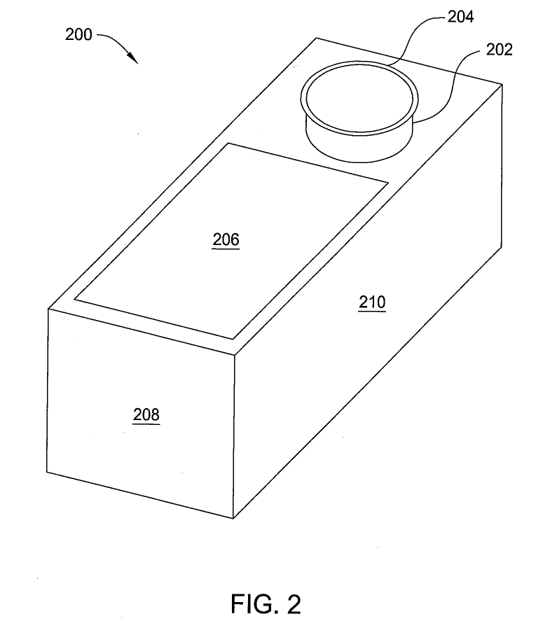

FIG. 2 is a schematic isometric view of a cooling block 200 according to one embodiment of the invention. The cooling block comprises a flange 202 extending from the body. A sealing flange 204 is coupled to the flange 202 to couple the cooling block to a remote plasma source. A removable panel 206 may be present on a side 210 of the cooling block. The plasma entering the cooling block 200 may flow into the cooling block 200 through the flange 202 and down towards the end 208.

When the cooling block 200 is formed from a unitary piece of material, one or more panels 206 may be cut into the sides 210 of the cooling block 200. The panels 206 permit portions inside the cooling block 200 to be hollowed out. Once sufficient material has been removed from the inside of the cooling block 200, the panel 206 may be re-coupled to the cooling block 210. The panel 206 may be coupled by welding or any other conventional fastening mechanism known in the art.

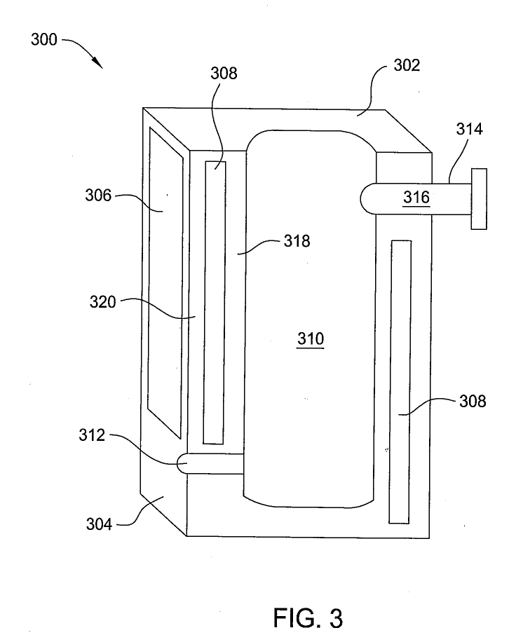

FIG. 3 is a schematic cross sectional isometric view of a cooling block 300 according to another embodiment of the invention. The cooling block 300 comprises a top end 302 and a plurality of sides 304. One or more panels 306 may be carved into one or more sides 304. The panels 306 may be cut out of the cooling block 300 to permit a space 308 to be carved between the inner body 318 and the outer body 320. In one embodiment, the inner body 318 and the outer body 320 comprise a unitary body. In another embodiment, the inner body 318 and the outer body 320 comprise separate entities coupled together. The inner body 318 may have a rectangular shape and the outer body 320 may have a rectangular shape.

A cavity 310 may be formed into the inner body 318. The cavity may have an open portion at the top end 302 to permit metrology through an optically transparent window (not shown) that may be coupled to the top side 302. The plasma may enter the cooling block 300 through a passage 316 within a flange 314 disposed adjacent the top side 302. The plasma may enter the cooling block 300 through the passage 316, flow perpendicular thereto and exit through a second passage 312 disposed near an end opposite to the top end 302. Cooling fluid may be continually provided within the space 308 between the inner body 318 and the outer body 320. The cooling fluid may for perpendicular to the direction of the plasma flowing through the passages 312, 316 and parallel to the plasma within the cavity 310. In one embodiment, the cooling fluid flows counter to the direction of flow of the plasma through the cavity 310. In another embodiment, the cooling fluid flows in the same direction as the plasma flowing through the cavity 310. The space 308 permits a greater surface area of the inner body 318 to be exposed to the cooling fluid as opposed to gun drilled cooling channels. In one embodiment, an entire perimeter of the inner body, for at least a portion of the body, is exposed to the cooling fluid. In another embodiment, greater than about 50 percent of the outside surface of the inner body 318 is exposed to the cooling fluid. In another embodiment, the greater than 75 percent is exposed.

It is to be understood that while the cooling block has been shown as a rectangle shaped structure, other structures are contemplated including round or non-uniform shaped structures.

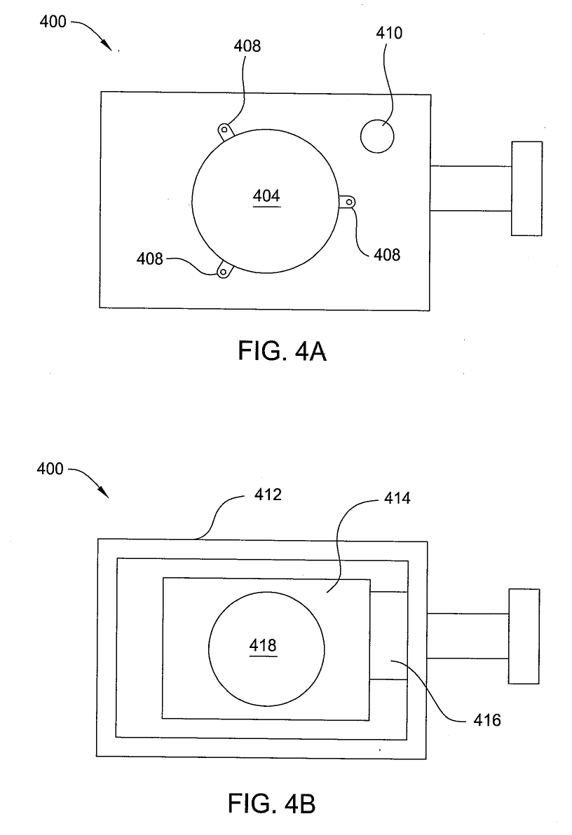

FIG. 4A is a schematic top view of a cooling block 400 according to one embodiment of the invention. FIG. 4B is a schematic bottom cross sectional view of the cooling block 400 of FIG. 4A. The cooling block 400 comprises a top end 402 having an optically transparent metrology window 404 coupled to the top end 402. One or more flanges 406 extend from the metrology window 404 to permit one or more fastening mechanisms 408 to couple the metrology window 404 to the top end 402. A cooling fluid inlet 410 may also be disposed on the top end 402. The outer body 412 of the cooling block 400 may be spaced from the inner body 414. The cavity 418 of the inner body 414 is shown. In one embodiment, the cavity 418 may comprise a circular or cylindrical shape while the inner body comprises a rectangular shape. The outer body 412 may be coupled to the inner body 414 by a plate 416. In one embodiment, the plate 416, outer body 412, and inner body 414 may comprise a unitary piece of material. In another embodiment, the flange 416, inner body 414, and outer body 412 may comprise separate pieces coupled together.

By coupling a cooling block between a remote plasma source and a resistor (or RF choke), the temperature of the plasma may be reduced and/or controlled. Additionally, the remote plasma source may be cooled. By maintaining a temperature control over the plasma and the remote plasma source, expansion and contraction of the apparatus components may be controlled and apparatus component damage may be reduced.

While the foregoing is directed to embodiments of the present invention, other and further embodiments of the invention may be devised without departing from the basic scope thereof, and the scope thereof is determined by the claims that follow.

1. A cooling block for coupling between a remote plasma source and a resistor, comprising:
an inner body having a cavity extending therethrough;
an outer body surrounding the inner body and spaced therefrom;
one or more plates extending between and coupled to the inner body and the outer body, the one or more plates occupying less than about 50 percent of the space; and
a flange coupled to and extending from the outer body, the flange enclosing a passage extending to the cavity.

2. The cooling block of claim 1, wherein the inner body, the outer body, the one or more plates, and the flange comprise a unitary body.

3. The cooling block of claim 1, wherein the inner body, the outer body, the one or more plates, and the flange comprise aluminum.

4. The cooling block of claim 1, wherein one plate of the one or more plates encloses a passage extending from the cavity to an outside surface of the outer body.

5. The cooling block of claim 1, wherein a first plate of the one or more plates extends between an end of the inner body and an end of the outer body, the first plate having an opening therethrough disposed over said space.

6. The cooling block of claim 5, wherein the first plate has a second opening disposed over the cavity.

7. The cooling block of claim 6, further comprising an optically transparent window disposed over the second opening and coupled to the first plate with one or more fastening mechanisms.

8. A plasma processing apparatus, comprising:
a processing chamber having a backing plate;
an inlet block coupled to the backing plate;
a power source coupled to the inlet block;
a resistor coupled to the inlet block;
a cooling block coupled to the resistor, the cooling block having a body with a flange extending therefrom, an inside portion having a passage therethrough for plasma to flow therein, an outside portion coupled to the inside portion with one or more plates such that greater than about 50 percent of an outside surface of the inside portion is spaced from the outside portion;
a fluid source coupled to the cooling block; and
a remote plasma source coupled to the flange of the cooling block.

9. The apparatus of claim 8, wherein the inner body, the outer body, the one or more plates, and the flange comprise a unitary body.

10. The apparatus of claim 8, wherein the inner body, the outer body, the one or more plates, and the flange comprise aluminum.

11. The apparatus of claim 8, wherein a first plate of the one or more plates extends between an end of the inner body and an end of the outer body, the first plate having an opening therethrough disposed over said space.

12. The apparatus of claim 11, wherein the first plate has a second opening disposed over the cavity.

13. The apparatus of claim 12, further comprising an optically transparent window disposed over the second opening and coupled to the first plate with one or more fastening mechanisms.

14. A plasma processing method, comprising:
igniting a plasma in a remote plasma source;
flowing the plasma from the remote plasma source through a cooling block, a resistor, an inlet block, and into a plasma processing chamber;
flowing a cooling fluid through the cooling block, wherein the plasma flows through a body disposed within the cooling block, and wherein the cooling fluid flows along the entire perimeter of the outside of the body for at least a portion of the length of the body;
processing a substrate in a plasma environment.

15. The method of claim 14, wherein the cooling fluid flows in the same direction as the plasma.

16. The method of claim 14, wherein the cooling block comprises aluminum.

17. The method of claim 14, wherein the plasma processing method is a plasma enhanced chemical vapor deposition method.

18. The method of claim 14, wherein the plasma enters the cooling block flowing in a direction substantially perpendicular to the direction of the cooling fluid.

19. The method of claim 18, wherein the plasma exits the cooling block flowing in a direction substantially perpendicular to the direction of the cooling fluid.

20. The method of claim 14, wherein the plasma exits the cooling block flowing in a direction substantially perpendicular to the direction of the cooling fluid.
